(19) United States
(12) Patent Application Publication
(10) Pub. No.: US 2010/0242641 A1
(43) Pub. Date: Sep. 30, 2010

(54) FITTING

(75) Inventor: Michael Mackert, Ruthen (DE)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: Kintec-Solution GmbH, Rietberg (DE)

(21) Appl. No.: 12/667,647

(22) PCT Filed: Jun. 26, 2008
(86) PCT No.: PCT/EP08/58178

§ 371 Date: May 19, 2010

(30) Foreign Application Priority Data
Jul. 5, 2007 (DE) 10 2007 031 378.2

(51) Int. Cl. F16H 19/02

(52) U.S. Cl. 74/89

(57) ABSTRACT

A fitting, especially of a piece of furniture used for sitting or lying down, includes a connecting bracket and a rotatable bracket that is pivotally connected thereto. The connecting bracket is provided with a force-transmitting element, particularly a toothed element, which may be arranged to be concentric with the shaft and is effectively connected to a linear adjusting element by means of a gear mechanism. The linear adjusting element is guided to be longitudinally adjustable along the rotatable bracket.

### BACKGROUND OF THE INVENTION

The present invention relates to a fitting, and in particular for a seat or recliner having a connection plate and a rotational plate pivotably connected thereto.

Such fittings are conventionally disposed in the side region of furniture, in particular seats or recliners, where they should take up as little space as possible so that they are not felt to have a detrimental effect on the appearance. They are also suitable for adjustable backrest or support parts of furniture. Furthermore, use in other applications is also feasible.

In addition, the fittings should have a certain holding force if they are formed as latching fittings. For this purpose, owing to the stresses arising, the latching teeth and the outer toothing of the latching fittings as well as the latching detent must be dimensioned and formed in such a manner that appropriate holding forces are achieved. In addition, the fittings should then also have a plurality of latching adjustments, for which purpose the toothing must have a corresponding number of teeth.

All in all the fittings should thus be formed as small and/or thin as possible while having a high level of stability.

In particular in the case of slim, narrow furniture with a metal structure or frame, such as seats and recliners for example, problems occur when using conventional latching fittings.

Thus, from DE 91 05 323 U1, a latching fitting is known in which the outer toothing is disposed between a stop cam on the one hand and a pressing lug on the other so that the whole active region which can be brought into operation with the detent pawl is defined by the stop cam on the one hand and the pressing lug on the other. In the case of this latching fitting, the pressing lug on the one hand and the stop cam on the other each protrude laterally outwards so that the latching fitting itself is relatively large in construction in the region of the joint.

From DE 20 2005 003 960 U1, a latching fitting is known in which the pressing lug is disposed between the stop cam and the outer toothing so that this no longer protrudes outwards and the latching plate as a whole can be kept narrower in the region of the outer toothing. However, owing to the geometry applied, this latching fitting is still of relatively large construction. Furthermore, the size of the region of the toothing is reduced by the arrangement of the pressing lug so that the corresponding latching pivot region is reduced since the number of teeth is reduced.

From commonly assigned U.S. Patent Application Publication No. 2009/0309403 A1, a latching fitting of a seat or recliner is known, having a connection plate and a latching plate which is pivotably connected thereto and can be stopped in different angular positions. The latching plate has toothing disposed concentric to the joint axis, into which toothing a detent pawl rotatably mounted on the connection plate engages in the latching position, wherein the detent pawl is held in the disengaged position by a spring and is acted upon by the same spring in the engaged position. The particular feature of the latching fitting is that only a stop cam is provided on the latching plate to disengage the detent pawl by cooperation with a disengagement lug and that the detent pawl has an engaging surface which cooperates with the toothing for engagement purposes. This latching fitting is small and has a large holding force while having a simple construction.

### SUMMARY OF THE INVENTION

The present invention is directed to a fitting which provides a change in length during angular displacement, such as for use with footrests of seats or recliners. At that location the footrest becomes longer as it is folded out so that an enlarged contact surface for the legs and feet is available in spite of being of a smaller construction when in the folded-in condition. The present invention may also be applied to headrests.

The present invention provides a fitting in which an angular displacement is accompanied by a change in length. In addition, the construction size is as small as possible and the fitting—if it is formed as a latching fitting—has a large holding force and at the same time has a large possible range of latching displacement. In particular, the fitting is of such a small construction that it can be used in seats and recliners at different positions and for different functions without any problems.

A fitting for a seat or recliner, according to an aspect of the invention, includes a connection plate and a rotational plate pivotably connected thereto by a spindle. The connection plate has toothing disposed concentric to the spindle. The toothing is operatively connected via a gear mechanism to a linear displacement element. The linear displacement element is guided in a longitudinally displaceable manner on the rotational plate, in such a way that an angular displacement between the connection plate and the rotational plate is accompanied by a change in length.

Owing to the fact that the connection plate has toothing which is disposed concentric to the spindle and is operatively connected via a gear mechanism to a linear displacement element which is guided in a longitudinally displaceable manner on the rotational plate, then during rotation of the rotational plate with respect to the connection plate, i.e., an angular displacement, the rotation is converted via the gear mechanism into a linear Movement of the linear displacement element.

Owing to the use of a gear mechanism, the linear movement can be tailored to the angular displacement or rotation both in extent and also in the direction of the movement.

In one embodiment, the gear mechanism is operatively connected to the linear displacement element via a friction element and/or non-positive connection element, in particular a toothed rack. The toothed rack can, in turn, be connected to the linear displacement element in any conceivable way, e.g., screws, clamps, rivets, adhesive, welding, etc. The linear displacement element may be immovably connected to the friction element and/or non-positive connection element, in particular the toothed rack, so that the rotational movement from the gear mechanism produces a linear movement of the linear displacement element with respect to the rotational plate. When using a friction element, a friction roller, for example, can be used.

In order to improve the effect and smoothness of operation, the linear displacement element may be connected to the rotational plate via a friction-reducing bearing. The bearing may have an elongate hole in the linear displacement element, into which at least two bolts engage, which extend between the rotational plate and the linear displacement element. The bolts can form or comprise rollers for support on the elongate hole. However, it is also feasible to use a flat roller bearing or a slide bearing. The use of a rod, which is guided in two bores, provided, e.g., in corresponding bolts, can also be considered as a further alternative for bearing and supporting purposes.

A compact construction is achieved when the gear mechanism is connected on the input side to the toothing of the connection plate and on the output side to the toothed rack. The gear mechanism may have only a few mutually engaging toothed wheels which are tailored to each other and to the toothing on the connection plate in such a way that the desired extent and direction of the longitudinal displacement is achieved. The gear mechanism may thus be generally connected on the input side to the force transfer element and on the output side to the friction element and/or non-positive connection element.

The gear mechanism may be supported on the rotational plate and disposed in a protected manner between the rotational plate and the linear displacement element. Therefore, a compact construction may be achieved in which at least one of the bolts can also be selectively used as a gear shaft.

If the fitting is formed as a latching fitting, then a latching mechanism which acts between the connection plate and rotational plate is preferably provided to stop the rotational plate in different angular positions, wherein the rotational plate, which has second toothing disposed concentric to the joint axis, into which a detent pawl rotatably mounted on the connection plate then engages in the latching position, wherein the detent pawl is held in the disengaged position by a spring and is acted upon by the same spring in the engaged position, wherein only a stop cam on the rotational plate is provided to disengage the detent pawl by cooperation with a disengagement lug and that the detent pawl has an engagement surface which cooperates with the toothing for engagement purposes as is known by commonly assigned U.S. Patent Application Publication No. 2009/0309403 A1.

Owing to the change in length associated with the angular displacement, the fittings in accordance with the invention are particularly suitable for displaceable headrest parts and footrest parts of seats and recliners, in particular easy chairs, but are not limited thereto.

### BRIEF DESCRIPTION OF THE DRAWINGS

Further features, details and advantages of the invention will become clear from the following description of an exemplified embodiment and with the aid of the drawing in which:

FIG. 1 is an exploded perspective view of a fitting in accordance with an embodiment the invention formed as a latching fitting, illustrated in the basic position;

FIG. 2 is a side elevation view of the latching fitting of FIG. 1;

FIG. 3 is a perspective view of the latching fitting of FIG. 1, wherein for greater clarity the latching mechanism and the rotational plate have been re-moved;

FIG. 4 is a side elevation view of the latching fitting of FIG. 1 seen in a partially rotated position; and

FIG. 5 is a side elevation view corresponding to FIG. 4, wherein for greater clarity the latching mechanism and rotational plate have again been re-moved.

### DESCRIPTION OF THE PREFERRED EMBODIMENT

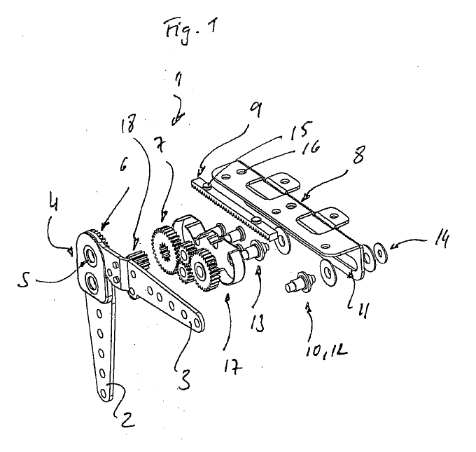

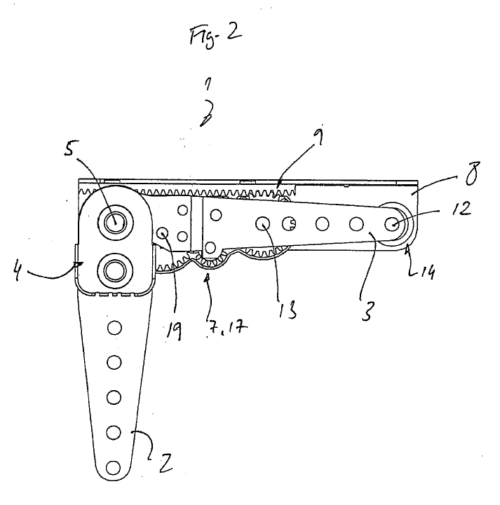

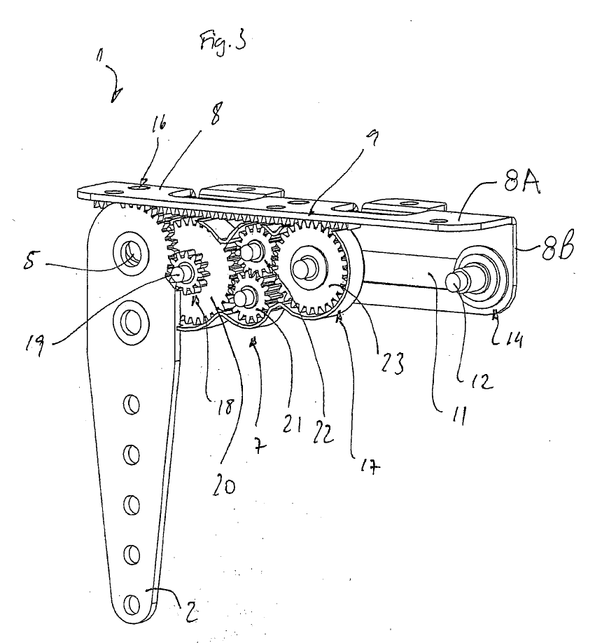

Referring now to the drawings and the illustrative embodiments depicted therein, FIGS. 1 to 5 show a fitting formed as a latching fitting and designated as a whole by 1. Fitting 1 may be used, for example, to mount a headrest or footrest of an easy chair, seat, recliner, or the like.

The latching fitting 1 has a connection plate 2 for attachment to the fixed part of an item of furniture and a rotational plate 3 for attachment to the displaceable part of the item of furniture, which can be rotated with respect to each other about a spindle 5.

Between the connection plate 2 and the rotational plate 3, a latching mechanism 4 is disposed which is responsible for the latching function. No further detail of latching mechanism 4 is given since it corresponds generally in structure and operation to the latching fitting disclosed in commonly assigned U.S. Patent Application Publication No. 2009/0309403 A1, the disclosure of which is hereby incorporated herein by reference.

The connection plate 2 has toothing 6, which is disposed concentric to the spindle 5, on the outside of its head, which toothing is operatively connected via a gear mechanism 7 to a linear displacement element 8 guided in a longitudinally displaceable manner on the rotational plate 3. The gear mechanism is arranged in such a way that a small movement of the connection plate 2 effects a greater movement of the linear displacement element 8.

For this purpose, the gear mechanism 7 is operatively connected to the linear displacement element 8 via a toothed rack 9, and the linear displacement element 8 is, in turn, immovably connected to the toothed rack 9, for which purpose the toothed rack 9 has protrusions 15 on the upper side, which are pressed in a snugly fitting manner into corresponding openings 16 in the linear displacement element 8.

The linear displacement element 8 is connected via a friction-reducing bearing 10 to the rotational plate 3, which, in the present case, has an elongate hole 11 in the linear displacement element 8, into which two bolts 12, 13 engage, which extend between the rotational plate 3 and the linear displacement element 8. Together with corresponding discs, the bolts 12, 13 form rollers 14 on the elongate hole 11 for support and guidance purposes.

The linear displacement element 8 itself is formed as an elongate angular piece, wherein one limb 8A (upper side) serves as a connection surface for the moveable part of the furniture (not shown) and the other limb 8B receives the elongate hole 11.

The gear mechanism 7 is disposed between the rotational plate 3 and the linear displacement element 8 and is supported on the rotational plate 3. A cover 17 may be provided for protection.

On the input side the gear mechanism 7 is connected to the toothing 6 of the connection plate 2 and on the output side is connected to the toothed rack 9.

For this purpose, a first toothed wheel 18, the shaft of which 19 is received on the rotational plate 3, meshes with the toothing 6 of the connection plate 2. A second toothed wheel 20 is disposed rotationally fixed to the toothed wheel 18 on the same shaft 19 and transfers the movement to the toothed rack 9 via three further toothed wheels 21, 22 and 23. The shafts of the toothed wheels 21, 22 and 23 are also received on the rotational plate 3; Wherein the shaft of the output-side toothed wheel 23 is formed by the bolt 13.

The manner of operation of the fitting during rotation or angular displacement is described as follows.

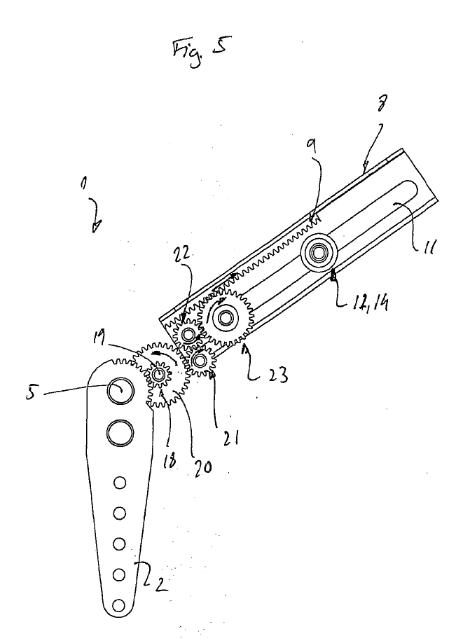

If, starting from the basic position (FIGS. 1 to 3), the rotational plate 3 is rotated counter clockwise with respect to the connection plate 2, the toothing 6 causes rotation of the toothed wheel 18 and 20 in the counter clockwise direction. This, in turn, causes rotation of the toothed wheel 21 in the clockwise direction, which effects a counter clockwise rotation of the toothed wheel 22 and ultimately on the output side a clockwise rotation of the toothed wheel 23 (cf. arrows in FIG. 5).

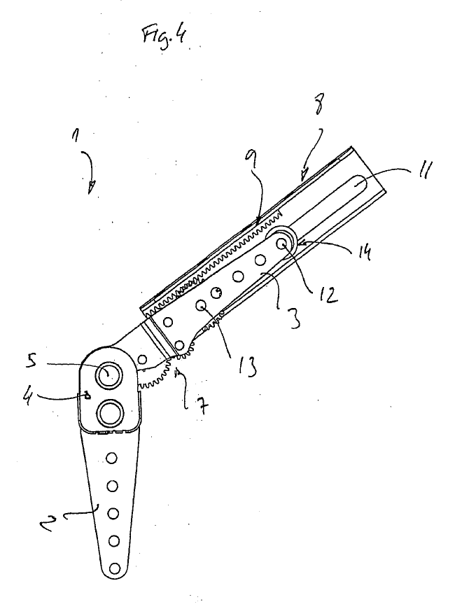

In this way, the toothed rack 9, which meshes with the toothed wheel 23, and correspondingly the linear displacement element 8, is linearly displaced with respect to the rotational plate 3 in the direction away from the spindle 5 (cf. FIG. 4) since it is supported in a non-rotational manner, by means of the elongate hole 11 and the bolts 12, 13, on the rotational plate 3.

Changes and modifications in the specifically described embodiments can be carried out without departing from the principles of the invention which is intended to be limited only by the scope of the appended claims, as interpreted according to the principles of patent law including the doctrine of equivalents.

### REFERENCE LIST

1 fitting
2 connection plate
3 rotational plate
4 latching mechanism
5 spindle
6 toothing
7 gear mechanism
8 linear displacement element
8A, B limb
9 toothed rack
10 bearing
11 elongate hole
12 bolt
13 bolt
14 rollers
15 protrusions
16 openings
17 cover
18 toothed wheel
19 shaft
20 toothed wheel
21 toothed wheel
22 toothed wheel
23 toothed wheel

1. Fitting for a seat or recliner, comprising:
a connection plate and a rotational plate pivotably connected thereto by a spindle;
said connection plate having toothing disposed concentric to the spindle;
said toothing being operatively connected via a gear mechanism to a linear displacement element, said linear displacement element being guided in a longitudinally displaceable manner on the rotational plate, in such a way that an angular displacement between said connection plate and said rotational plate is accompanied by a change in length.

2. Fitting as claimed in claim 1, wherein the gear mechanism is operatively connected to the linear displacement element via at least one chosen from a friction element and a non-positive connection element.

3. Fitting as claimed in claim 2, wherein the linear displacement element is immovably connected to the at least one chosen from a friction element and a non-positive connection element.

4. Fitting as claimed in claim 3, wherein the linear displacement element is connected to the rotational plate via a friction-reducing bearing.

5. Fitting as claimed in claim 4, wherein the bearing has an elongate hole in the linear displacement element, into which at least two bolts engage, wherein said at least two bolts extend between the rotational plate and the linear displacement element.

6. Fitting as claimed in claim 5, wherein the bolts form rollers for support on the elongate hole.

7. Fitting as claimed in claim 2, wherein the gear mechanism is connected on the input side to the toothing of the connection plate and on the output side to the at least one chosen from a friction element and a non-positive connection element.

8. Fitting as claimed in claim 1, wherein the gear mechanism is supported on the rotational plate.

9. Fitting as claimed in claim 1, wherein the gear mechanism is disposed between the rotational plate and the linear displacement element.

10. Fitting as claimed in claim 5, wherein at least one of the bolts serves as a gear shaft.

11. Fitting as claimed in claim 2, wherein said at least one chosen from a friction element and a non-positive connection element comprises a toothed rack.

12. Fitting as claimed in claim 2, wherein the linear displacement element is connected to the rotational plate via a friction-reducing bearing.

13. Fitting as claimed in claim 12, wherein the bearing has an elongate hole in the linear displacement element, into which at least two bolts engage, wherein said at least two bolts extend between the rotational plate and the linear displacement element.

14. Fitting as claimed in claim 13, wherein the bolts form rollers for support on the elongate hole.

15. Fitting as claimed in claim 12, wherein the gear mechanism is connected on the input side to the toothing of the connection plate and on the output side to the at least one chosen from a friction element and a non-positive connection element.

16. Fitting as claimed in claim 12, wherein the gear mechanism is supported on the rotational plate.

17. Fitting as claimed in claim 12, wherein the gear mechanism is disposed between the rotational plate and the linear displacement element.

18. Fitting as claimed in claim 2, wherein the gear mechanism is supported on the rotational plate.

19. Fitting as claimed in claim 2, wherein the gear mechanism is disposed between the rotational plate and the linear displacement element.

20. Fitting as claimed in claim 9, wherein at least one of the bolts serves as a gear shaft.
